(19) United States
(12) Patent Application Publication
(10) Pub. No.: US 2025/0322610 A1
(43) Pub. Date: Oct. 16, 2025

(54) ELECTRONIC DEVICE, METHOD, AND COMPUTER-READABLE STORAGE MEDIUM FOR ACQUIRING INFORMATION INDICATING SHAPE OF BODY FROM ONE OR MORE IMAGES

(71) Applicants: NCSOFT Corporation, Seoul (KR); KWANGWOON UNIVERSITY INDUSTRY-ACADEMIC COLLABORATION FOUNDATION, Seoul (KR)

(72) Inventors: Sangjun AHN, Seongnam-si (KR); Sunwon JEONG, Seongnam-si (KR); Sungbum PARK, Seongnaim-si (KR); Juyong CHANG, Seoul (KR); Sungho CHUN, Seoul (KR)

(73) Assignees: NCSOFT Corporation, Seoul (KR); KWANGWOON UNIVERSITY INDUSTRY-ACADEMIC COLLABORATION FOUNDATION, Seoul (KR)

(21) Appl. No.: 19/251,066

(22) Filed: Jun. 26, 2025

Related U.S. Application Data
(63) Continuation of application No. PCT/KR2022/021429, filed on Dec. 27, 2022.

(51) Int. Cl. G06T 17/20; G06T 7/00; G06T 7/60; G06V 10/82; G06V 40/10

(52) U.S. Cl. CPC G06T 17/20; G06T 7/60; G06T 7/97; G06V 10/82; G06V 40/10

(57) ABSTRACT

An electronic device according to an embodiment includes a communication circuit and a processor. The processor is configured to: obtain a plurality of images; obtain feature information associated with the plurality of images, the feature information indicating a first probability that a body part is present in the plurality of images; obtain, using encoding layers, code information associated with the body part having dimensions smaller than dimensions associated with the feature information; obtain, using decoding layers, heatmap information indicating a second probability that one or more vertices corresponding to the body part exist, the second probability also indicating that the body part has dimensions greater than dimensions associated with the code information; and obtain mesh information that indicates a shape of the body in a virtual three-dimensional space, the mesh information comprising being based on the one or more vertices.

### CROSS-REFERENCE TO RELATED APPLICATION

This application is a continuation of International Application No. PCT/KR2022/021429, filed on Dec. 27, 2022, with the Korean intellectual Property Office, the disclosure is incorporated herein by reference in its entirety.

### BACKGROUND

### 1. Technical Field

The present disclosure relates to an electronic device, a method, and a computer-readable storage medium for obtaining information indicating a shape of a body from one or more images.

### 2. Related Art

Recently, there has been in increasing interest in technology that represents a shape of a body based on a three-dimensional coordinate system by photographing the body and interpreting the photographed image through a neural network. The neural network may be a model that has an ability to solve a specific problem by adjusting intensity of synaptic coupling through learning with respect to a node that forms a network through the synaptic coupling. This neural network may be utilized to identify a plurality of images of the body obtained from different viewpoints.

### SUMMARY

According to an embodiment, an electronic device may include communication circuitry and at least one processor comprising circuitry. According to an embodiment, the at least one processor may obtain, from the communication circuitry and using a plurality of cameras, a plurality of images in which at least a part of a body is captured; obtain feature information associated with the plurality of images, the feature information indicating a first probability that a body part is present in the plurality of images; obtain, based on the feature information being input into a plurality of encoding layers, code information associated with the body part having one or more dimensions smaller than one or more dimensions associated with the feature information; obtain, based on the code information being input into a plurality of decoding layers, heatmap information indicating a second probability that one or more vertices corresponding to the body part exist, the second probability also indicating that the body part has one or more dimensions greater than one or more dimensions associated with the code information; and obtain mesh information that indicates a shape of the body in a virtual three-dimensional space, the mesh information comprising being based on the one or more vertices.

According to an embodiment, a method for identifying a body part in images. The method may be executed by one or more processors of an electronic device. The method may include obtaining a plurality of images in which at least part of a body is captured; obtaining feature information associated with the plurality of images, the feature information indicating a first probability that a body part is present in the plurality of images; obtaining, based on the feature information being input into a plurality of encoding layers, code information associated with the body part having one or more dimensions smaller than one or more dimensions associated with the feature information; obtaining, based on the code information being input into a plurality of decoding layer, heatmap information indicating a second probability that one or more vertices corresponding to the body part exist, the second probability also indicating that the body part has one or more dimensions greater than one or more dimensions associated with the code information the code information; and obtaining mesh information that indicates a shape of the body in a virtual three-dimensional space, the mesh information comprising being based on the one or more vertices.

According to an embodiment, a computer-readable storage medium may store one or more instructions. According to an embodiment, the instructions, when executed by at least one processor of an electronic device, may cause the electronic device to obtain, from the communication circuitry and using a plurality of cameras, a plurality of images in which at least a part of a body is captured; obtain feature information associated with the plurality of images, the feature information indicating a first probability that a body part is present in the plurality of images; obtain, based on the feature information being input into a plurality of encoding layers, code information associated with the body part having one or more dimensions smaller than one or more dimensions associated with the feature information; obtain, based on the code information being input into a plurality of decoding layers, heatmap information indicating a second probability that one or more vertices corresponding to the body part exist, the second probability also indicating that the body part has one or more dimensions greater than one or more dimensions associated with the code information; and obtain mesh information that indicates a shape of the body in a virtual three-dimensional space, the mesh information comprising being based on the one or more vertices.

### BRIEF DESCRIPTION OF DRAWINGS

FIG. 1 is a block diagram illustrating a functional configuration of an electronic device according to an embodiment.

FIG. 2 is an exemplary diagram of a neural network obtained by an electronic device from a set of parameters stored in memory, according to an embodiment.

FIG. 3 illustrates an example of an environment including an electronic device according to an embodiment.

FIG. 4 illustrates an example of a process for an electronic device to obtain feature information from a plurality of images, according to an embodiment.

FIG. 5 illustrates an example of a process for an electronic device to obtain mesh information from feature information, according to an embodiment.

FIG. 6 illustrates an example of a process of training a plurality of encoding layers and a plurality of decoding layers according to an embodiment.

FIG. 7 illustrates an example of a process of training a plurality of encoding layers according to an embodiment.

FIG. 8 illustrates an example of a process for an electronic device to obtain mesh information from a plurality of images obtained at different timings, according to an embodiment.

FIG. 9 illustrates an example of an environment including an electronic device according to an embodiment.

FIG. 10 is a flowchart for describing an operation of an electronic device according to an embodiment.

FIG. 11 is a flowchart for describing an operation of an electronic device according to an embodiment.

### DETAILED DESCRIPTION

In a case that a body is captured from different viewpoints, each of a plurality of obtained images may include a shape of the body viewed from different angles. In most studies, three-dimensional body reconstruction technology has represented a shape of the body on a virtual three-dimensional space by simply combining the plurality of images. In a case of simply combining the plurality of images, accuracy of a reconstructed body shape may be low. In a case that the accuracy of the reconstructed body shape is low, the shape of the body represented in the virtual three-dimensional space may be different from the shape of the body captured in the images.

The technical problems to be solved and the solutions proposed in this document are not limited to those described above. A person of ordinary skill in the art will clearly understand the fields and problems in the art to which the present disclosure relates, from the following description.

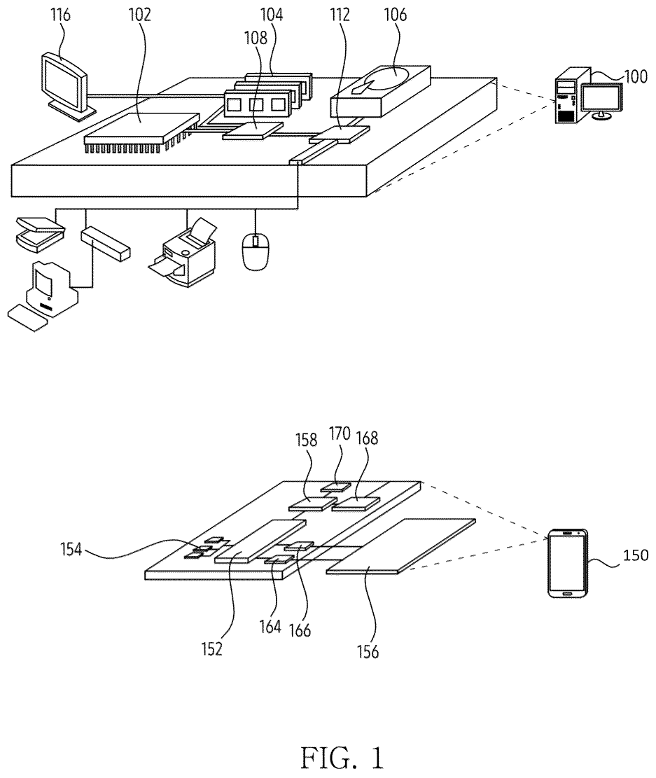

FIG. 1 is a simplified block diagram illustrating a functional configuration of an electronic device according to an embodiment.

Referring to FIG. 1, an electronic device 100 according to an embodiment may include a processor 102, memory 104, a storage device 106, a high-speed controller 108 (e.g., a northbridge, a main controller hub (MCH)), a low-speed controller 112 (e.g., a southbridge, an input/output (I/O) controller hub (ICH)). In the electronic device 100, each of the processor 102, the memory 104, the storage device 106, the high-speed controller 108, and the low-speed controller 112 may be interconnected using various buses. For example, the processor 102 may process instructions for execution in the electronic device 100 to display graphical information with respect to a graphical user interface (GUI) on an external input/output device, such as a display 116 connected to the high-speed controller 108. The instructions may be included in the memory 104 or the storage device 106. The instructions, when executed by the processor 102, may cause the electronic device 100 to perform one or more operations described above and/or one or more operations described below. According to embodiments, the processor 102 may be configured with a plurality of processors including a communication processor and a graphical processing unit (GPU).

For example, the memory 104 may store information in the electronic device 100. For example, the memory 104 may be a volatile memory unit or units. For another example, the memory 104 may be a non-volatile memory unit or units. For still another example, the memory 104 may be another type of a computer-readable medium, such as a magnetic or optical disk.

For example, the storage device 106 may provide a mass storage space to the electronic device 100. For example, the storage device 106 may be a computer-readable medium, such as a hard disk device, an optical disk device, flash memory, a solid-state memory device, or an array of devices in a storage area network (SAN).

For example, the high-speed controller 108 may manage bandwidth-intensive operations for the electronic device 100, while the low-speed controller 112 may manage low-bandwidth-intensive operations for the electronic device 100. For example, the high-speed controller 108 may be coupled to the memory 104 and to the display 116 through the GPU or an accelerator, while the low-speed controller 112 may be coupled to the storage device 106 and to various communication ports (e.g., a universal serial bus (USB), Bluetooth, Ethernet, and wireless Ethernet) for communication with external electronic devices (e.g., a keyboard, a transducer, a scanner, or a network device (e.g., a switch or a router)).

According to an embodiment, an electronic device 105 may be another example of the electronic device 100. The electronic device 105 may include a processor 152, memory 154, an input/output device such as a display 156 (e.g., an organic light emitting diode (OLED) display or another suitable display), a communication interface 158, and a transceiver 162. Each of the processor 152, the memory 154, the input/output device, the communication interface 158, and the transceiver 162 may be interconnected using various buses.

For example, the processor 152 may process instructions included in the memory 154 to display the graphical information with respect to the GUI on the input/output device. The instructions, when executed by the processor 152, may cause the electronic device 105 to perform one or more operations described above and/or one or more operations described below. For example, the processor 152 may interact with a user through a display interface 164 and a control interface 166 coupled to the display 156. For example, the display interface 164 may include circuitry for driving the display 156 to provide visual information to the user, and the control interface 166 may include circuitry for receiving commands received from the user and converting the commands to provide them to the processor 152. According to embodiments, the processor 152 may be implemented as a chipset of chips including analog and digital processors.

For example, the memory 154 may store information in the electronic device 105. For example, the memory 154 may include at least one of one or more volatile memory units, one or more non-volatile memory units, or a computer-readable medium.

For example, the communication interface 158 may perform wireless communication between the electronic device 105 and an external electronic device through various communication techniques such as a cellular communication technique, a Wi-Fi communication technique, an NFC technique, or a Bluetooth communication technique, based on a link with the processor 152. For example, the communication interface 158 may be coupled to a transceiver 168 to perform the wireless communication. For example, the communication interface 158 may be further coupled to a global navigation satellite system (GNSS) receiver module 170 to obtain location information of the electronic device 105.

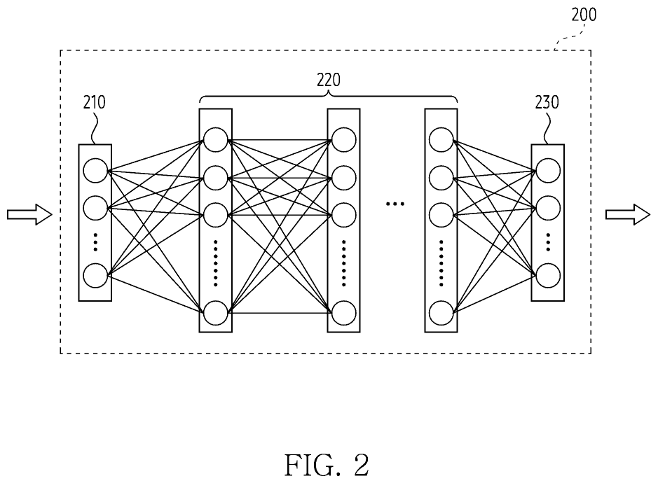

According to an embodiment, the electronic device 100 (and/or the electronic device 105) may obtain mesh information to indicate a shape of a body of a subject based on obtaining an image from a plurality of cameras. For example, the electronic device 100 (and/or the electronic device 105) may obtain mesh information for reconstructing the shape of the body in a virtual three-dimensional space from a plurality of images of the body photographed from different viewpoints. The electronic device 100 (and/or the electronic device 105) may utilize a neural network based on a trained encoder-decoder model to obtain the mesh information. The encoder-decoder model may be trained based on truth data (e.g., ground truth) with respect to a human body structure. The electronic device 100 (and/or the electronic device 105) may obtain data (e.g., a latent code) for obtaining the mesh information between an encoder model and a decoder model. For example, an encoder model included in the encoder-decoder model may be trained to obtain data for obtaining the mesh information from the plurality of images. For example, an example of a neural network including the encoder-decoder model may be described through FIG. 2.

FIG. 2 is an exemplary diagram for describing a neural network obtained by an electronic device from a set of parameters stored in memory, according to an embodiment.

Referring to FIG. 2, a set of parameters related to a neural network 200 may be stored in memory (e.g., the memory 104 of FIG. 1) of the electronic device (e.g., the electronic device 100 of FIG. 1) according to an embodiment. The neural network 200 is a recognition model implemented in software or hardware that mimics computational capability of a biological system by using a large number of artificial neurons (or nodes). The neural network 200 may perform a human cognitive function or a learning process through the artificial neurons. The parameters related to the neural network 200 may indicate, for example, a plurality of nodes included in the neural network 200 and/or a weight assigned to a connection between the plurality of nodes. The number of neural networks 200 stored in the memory 104 is not limited to what is illustrated in FIG. 2, and sets of parameters corresponding to each of a plurality of neural networks may be stored in the memory 104.

A model trained by the electronic device 100 according to an embodiment may be implemented based on the neural network 200 indicated based on a plurality of sets of parameters stored in the memory 104. Neurons of the neural network 200 corresponding to the model may be distinguished according to a plurality of layers. The neurons may be indicated by a connection line connecting a specific node included in a specific layer and another node included in another layer different from the specific layer, and/or by a weight assigned to the connection line. For example, the neural network 200 may include an input layer 210, hidden layers 220, and an output layer 230. The number of the hidden layers 220 may vary according to an embodiment.

The input layer 210 may receive a vector (e.g., a vector having elements corresponding to the number of nodes included in the input layer 210) indicating input data. Based on the input data, signals generated from each of nodes in the input layer 210 may be transmitted to the hidden layers 220 from the input layer 210. The output layer 230 may generate output data of the neural network 200 based on one or more signals received from the hidden layers 220. The output data may include, for example, a vector having elements mapped to each of nodes included in the output layer 230.

The hidden layers 220 may be located between the input layer 210 and the output layer 230, and may change the input data transmitted through the input layer 210. For example, as the input data received through the input layer 210 is propagated sequentially along the hidden layers 220 from the input layer 210, the input data may be gradually changed based on a weight connecting nodes of different layers.

As described above, each of the layers (e.g., the input layer 210, the hidden layers 220, and the output layer 230) included in the neural network 200 may include a plurality of nodes. The hidden layers 220 may be convolution filters or fully connected layers in a convolutional neural network (CNN), or various types of filters or layers grouped based on a special function or characteristic.

A structure in which nodes are connected between different layers is not limited to an example of FIG. 2. In an embodiment, one or more hidden layers 220 may be a layer based on a recurrent neural network (RNN) in which an output value is inputted back to a hidden layer at current time. In an embodiment, based on Long Short-Term Memory (LSTM), the neural network 200 may further include one or more gates (and/or filters) to discard, maintain for a relatively long period of time, or maintain for a relatively short period of time, at least one of values of the nodes. The neural network 200 according to an embodiment may form a deep neural network by including numerous hidden layers 220. Training a deep neural network is called deep learning. A node included in the hidden layers 220 may be referred to as a hidden node.

Nodes included in the input layer 210 and the hidden layers 220 may be connected to each other through a connection line with a weight, and nodes included in the hidden layers 220 and the output layer 230 may also be connected to each other through a connection line with a weight. Tuning and/or training the neural network 200 may mean changing weights between the nodes included in each of the layers (e.g., the input layer 210, the hidden layers 220, and/or the output layer 230) included in the neural network 200. Tuning the neural network 200 may be performed based on, for example, supervised learning and/or unsupervised learning.

The electronic device 100 according to an embodiment may train a model 240 based on the supervised learning. The supervised learning may mean training the neural network 200 using a set of paired input data and output data. For example, in a state of receiving input data included in the set, the neural network 200 may be tuned to decrease a difference between output data outputted from the output layer 230 and output data included in the set. As the number of the sets increases, the neural network 200 may generate generalized output data by one or more of the sets with respect to other input data distinct from the set.

The electronic device 100 according to an embodiment may tune the neural network 200 based on reinforcement learning in the unsupervised learning. For example, the electronic device 100 may change policy information used by the neural network 200 to control an agent based on an interaction between the agent and an environment. The electronic device 100 according to an embodiment may cause a change in the policy information by the neural network 200 in order to maximize a goal and/or a reward of the agent by the interaction. The neural network 200 may be trained to obtain an output value based on identifying an input value. Hereinafter, a method for reconstructing a shape of a body in a virtual three-dimensional space from a plurality of images using the neural network 200 by the electronic device 100 will be described.

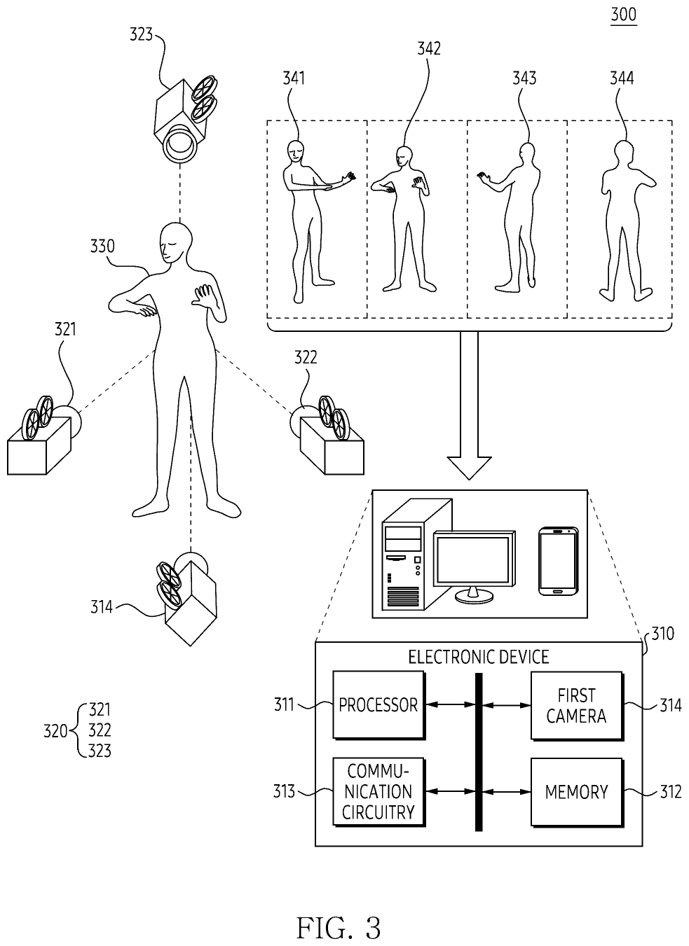

FIG. 3 illustrates an example of an environment including an electronic device according to an embodiment.

Referring to FIG. 3, an environment 300 according to an embodiment may include an electronic device 310 and/or one or more second cameras 320. The electronic device 310 of FIG. 3 may be substantially the same as at least one of the electronic device 100 and the electronic device 105 of FIG. 1, so that a redundant description will be omitted. For example, the electronic device 310 of FIG. 3 may be substantially the same as the electronic device 100 of FIG. 1. For example, the electronic device 310 of FIG. 3 may be substantially the same as the electronic device 105 of FIG. 1.

The electronic device 310 may include a processor 311, memory 312, communication circuitry 313, and/or a first camera 314. The processor 311 of FIG. 3 may be substantially the same as the processor 102 and/or the processor 152 of FIG. 1, the memory 312 of FIG. 3 may be substantially the same as the memory 104 and/or the memory 154 of FIG. 1, and the communication circuitry 313 of FIG. 3 may be substantially the same as the communication interface 158 of FIG. 1, so that a redundant description will be omitted.

The first camera 314 may be utilized to capture at least a portion of a body 330. The first camera 314 may obtain an image based on receiving light from the outside of the electronic device 310. The first camera 314 may capture at least a portion of the body 330 based on receiving light from the body 330. For example, the first camera 314 may direct a front surface of the body 330. The first camera 314 may obtain a first image 341 including the front surface of the body 330 by directing the front surface of the body 330. For example, the first camera 314 may include an image sensor configured to obtain an image based on receiving light from the outside of the electronic device 310. According to an embodiment, the first camera 314 may be operably coupled to the processor 311. For example, the first camera 314 may be disposed in the electronic device 310 and operably coupled to the processor 311. However, it is not limited thereto. For example, the first camera 314 may be disposed outside the electronic device 310 and operably coupled to the processor 311 through the communication circuitry 313.

According to an embodiment, the processor 311 of the electronic device 310 may obtain a plurality of images 342, 343, and 344 from the one or more second cameras 320 through the communication circuitry 313. The one or more second cameras 320 may be utilized to capture at least a portion of the body 330. The one or more second cameras 320 may be configured to obtain an image based on receiving light from the outside of the one or more second cameras 320. According to an embodiment, the one or more second cameras 320 may direct the body 330 from different angles. The one or more second cameras 320 may capture different body parts of the body 330 based on different viewpoints by directing the body 330 from different angles. A viewpoint may mean a range that a camera may capture at a specific timing, and the corresponding expression may be used equally below unless otherwise stated. For example, a portion 321 of the one or more second cameras 320 may capture a left side surface of the body 330 by directing the left side surface of the body 330. For example, another portion 322 of the one or more second cameras 320 may capture a right side surface of the body 330 by directing the right side surface of body 330. For example, still another 323 of the one or more second cameras 320 may capture a rear surface of the body 330 by directing the rear surface of body 330. However, it is not limited thereto, and a dispositional relationship of the one or more second cameras 320 may be variously changed. In addition, although the number of the one or more second cameras 320 is illustrated as three in FIG. 3, this is for convenience of explanation. The number of the one or more second cameras 320 for capturing the body 330 is not limited as illustrated in FIG. 3.

According to an embodiment, a plurality of images 341, 342, 343, and 344 may be obtained by the first camera 314 and the one or more second cameras 320. For example, the first image 341 may be obtained by the first camera 314, and the second image 342, the third image 343, and/or the fourth image 344 may be obtained by the one or more second cameras 320. According to an embodiment, the plurality of images 341, 342, 343, and 344 may be obtained as the body 330 is captured from different viewpoints. For example, the first image 341 may include an image of the front surface of the body 330 by being obtained by the first camera 314 directing the front surface of the body 330. For example, the second image 342 may include an image of the left side surface of the body 330 by being obtained by the portion 321 of the one or more second cameras 320 directing the left side surface of the body 330. For example, the third image 343 may include an image of the right side surface of the body 330 by being obtained by the another portion 322 of the one or more second cameras 320 directing the right side surface of the body 330. The fourth image 344 may include an image of the rear surface of the body 330 by being obtained by the still another 323 of the one or more second cameras 320 directing the rear surface of the body 330.

According to an embodiment, the plurality of images 341, 342, 343, and 344 obtained by the first camera 314 and the one or more second cameras 320 may be images of a shape of the body 330 captured from different angles at the same timing. For example, the plurality of images 341, 342, 343, and 344 may be images of a posture of the body 330 captured from different angles at the same timing. For example, the body 330 may maintain a specific shape while being photographed by the first camera 314 and the one or more second cameras 320. For example, each of the first camera 314 and the one or more second cameras 320 may obtain the plurality of images 341, 342, 343, and 344 including the body 330 based on receiving light from the body 330 while the specific shape of the body 330 is maintained. According to an embodiment, each of the first camera 314 and the one or more second cameras 320 may move while the shape of the body 330 is maintained. For example, the movement of the first camera 314 and the one or more second cameras 320 may include a change in an angle at which each of the first camera 314 and the one or more second cameras 320 directs the body 330 while maintaining a state in which each of the first camera 314 and the one or more second cameras 320 directs the body 330. For example, the movement of the first camera 314 and the one or more second cameras 320 may include a change in a distance between the first camera 314 and the one or more second cameras 320 and the body 330 while maintaining the state in which each of the first camera 314 and the one or more second cameras 320 directs the body 330. However, it is not limited thereto. For example, the plurality of images 341, 342, 343, and 344 obtained by the first camera 314 and the one or more second cameras 320 may be images of the shape of the body 330 captured at different timings. For example, the plurality of images 341, 342, 343, and 344 may be images of the shape of the body maintained for a preset time captured at different timings from different angles. For example, the plurality of images 341, 342, 343, and 344 may be images of a changing shape of the body captured at different timings from different angles.

According to an embodiment, the processor 311 of the electronic device 310 may obtain the plurality of images 341, 342, 343, and 344 in which a body part included in the body 330 is captured, from the first camera 314 and the one or more second cameras 320 connected through the communication circuitry 313. The body part of the body 330 may mean joints included in the body 330, but is not limited thereto.

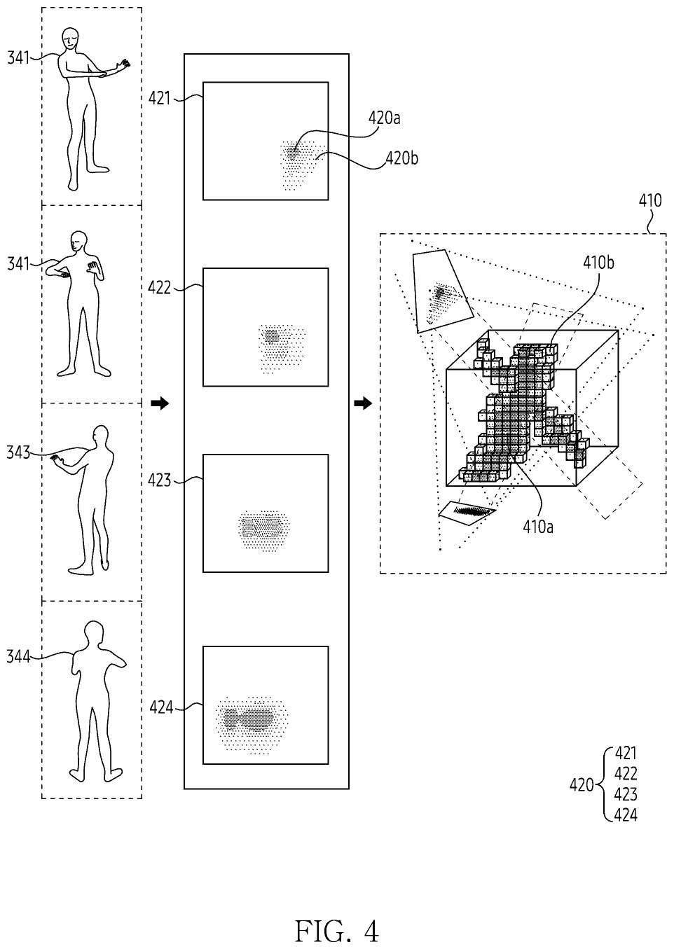

According to an embodiment, the processor 311 may obtain feature information from the plurality of images 341, 342, 343, and 344. For example, an operation of the processor 311 obtaining the feature information from the plurality of images 341, 342, 343, and 344 may be described with reference to FIG. 4. Hereinafter, it is described that the processor 311 operates based on receiving four images, but an operation of the processor 311 according to an embodiment is not limited thereto.

FIG. 4 illustrates an example of a method for an electronic device to obtain feature information from a plurality of images according to an embodiment.

Referring to FIG. 4, according to an embodiment, a processor (e.g., the processor 311 of FIG. 3) may obtain three-dimensional feature information 410 based on obtaining a plurality of images 341, 342, 343, and 344. The processor 311 may obtain the three-dimensional feature information 410 indicating a probability that a body part in a body (e.g., the body 330 of FIG. 3) exists, from the plurality of images 341, 342, 343, and 344. For example, the processor 311 may obtain the three-dimensional feature information 410 indicating the probability that a body part in the body 330 exists based on identifying feature points of each of the plurality of images 341, 342, 343, and 344. The three-dimensional feature information 410 may indicate a probability that the body part exists in a virtual three-dimensional space. The three-dimensional feature information 410 may indicate the probability that the body part (e.g., a joint) exists in the virtual three-dimensional space in a form of a heat map. For example, a region 410a in which the probability that the body part exists is relatively high may include dots with a relatively high density, and a region 410b in which the probability that the body part exists is relatively low may include dots with a relatively low density. For example, a color of the region 410a in which the probability that a body part exists is relatively high may differ from a color of the region 410b in which the probability that the body part exists is relatively low.

According to an embodiment, the processor 311 may obtain two-dimensional feature information 420 indicating a probability that a body part exists, from the plurality of images 341, 342, 343, and 344. The two-dimensional feature information 420 may indicate a probability that a body part exists in a virtual two-dimensional space. The two-dimensional feature information 420 may include probability distributions indicating a probability that each of user's joints exists in the virtual two-dimensional space. For example, the two-dimensional feature information 420 may include information with respect to a probability distribution indicating a probability that a right shoulder joint of the user exists, information with respect to a probability distribution indicating a probability that a left shoulder joint of the user exists, information with respect to a probability distribution indicating a probability that a hip joint of the user exists, and the like. The two-dimensional feature information 420 may indicate the probability that the body part exists in a virtual two-dimensional space in the form of the heat map. For example, a region 420a in which the probability that the body part exists is relatively high may include dots with a relatively high density, and a region 420b in which the probability that the body part exists is relatively low may include dots with a relatively low density. For example, a color of the region 420a in which the probability that the body part exists is relatively high may differ from a color of the region 420b in which a probability that the body part exists is relatively low. For example, the processor 311 may obtain the two-dimensional feature information 420 based on inputting the plurality of images 341, 342, 343, and 344 to a backbone network. The processor 311 may obtain the two-dimensional feature information 420 corresponding to each of the plurality of images 341, 342, 343, and 344 based on obtaining the plurality of images 341, 342, 343, and 344. For example, the processor 311 may obtain first two-dimensional feature information 421 corresponding to the first image 341 based on obtaining the first image 341. For example, the processor 311 may obtain second two-dimensional feature information 422 corresponding to the second image 342 based on obtaining the second image 342. For example, the processor 311 may obtain third two-dimensional feature information 423 corresponding to the third image 343 based on obtaining the third image 343. For example, the processor 311 may obtain fourth two-dimensional feature information 424 corresponding to the fourth image 344 based on obtaining the fourth image 344.

According to an embodiment, the processor 311 may obtain the three-dimensional feature information 410 based on obtaining the two-dimensional feature information 420. The processor 311 may be configured to obtain the three-dimensional feature information 410 by unprojecting the two-dimensional feature information 420 onto the virtual three-dimensional space. For example, the processor 311 may obtain the three-dimensional feature information 410 from the two-dimensional feature information 420 based on inputting the two-dimensional feature information 420 to an algorithm for unprojecting the two-dimensional feature information 420 onto the virtual three-dimensional space. However, it is not limited thereto, and the processor 311 may obtain the three-dimensional feature information 410 from the two-dimensional feature information 420 based on inputting the two-dimensional feature information 420 to a trained neural network. According to an embodiment, the three-dimensional feature information 410 may indicate a probability that a body part captured in the plurality of images 341, 342, 343, and 344 exists in the virtual three-dimensional space. For example, the processor 311 may obtain the three-dimensional feature information 410 by unprojecting the first image 341, the second image 342, the third image 343, and the fourth image 344 onto the virtual three-dimensional space.

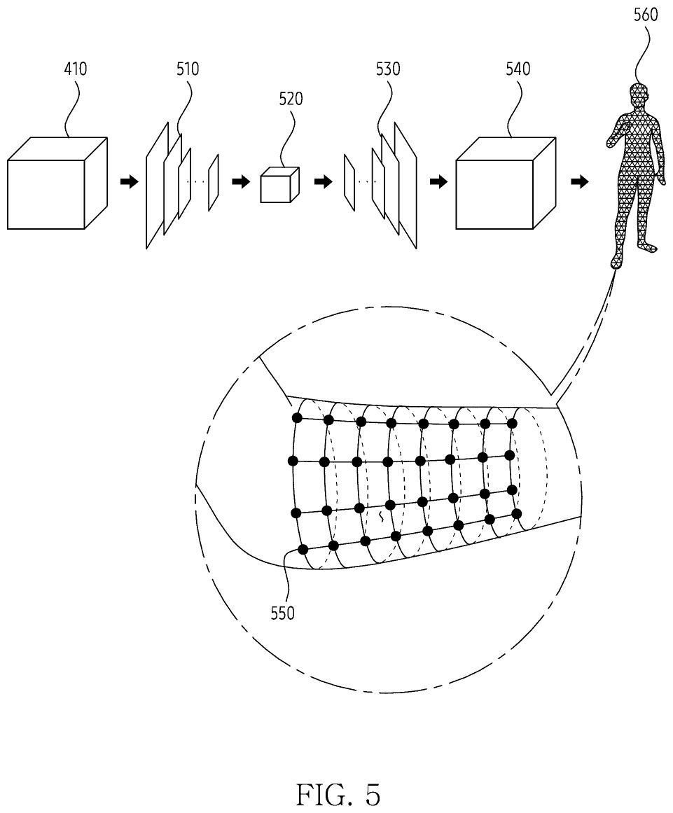

According to an embodiment, the processor 311 may obtain code information with respect to a body part having a dimension lower than the three-dimensional feature information 410, based on obtaining the three-dimensional feature information 410. An operation of the processor 311 obtaining the code information may be described, for example, with reference to FIG. 5.

FIG. 5 illustrates an example of a method for an electronic device to obtain mesh information from feature information, according to an embodiment.

Referring to FIG. 5, according to an embodiment, a processor (e.g., the processor 311 of FIG. 3) may obtain code information 520 based on inputting three-dimensional feature information 410 to a plurality of encoding layers 510. The plurality of encoding layers 510 may include a plurality of layers sequentially connected from an input layer to which the three-dimensional feature information 410 is inputted. The layers included in the plurality of encoding layers 510 may be connected by kernels (or filters) used for a convolution operation. A neural network (or model) including the plurality of encoding layers 510 being trained (or learned) may include an operation in which parameters (or weights) included in the kernels (or the filters) are tuned. A dimension of the input layer of the plurality of encoding layers 510 to which the three-dimensional feature information 410 is inputted may be greater than a dimension of an output layer of the plurality of encoding layers 510 from which the code information 520 is outputted. A dimension of the plurality of encoding layers 510 may be gradually decreased. A dimension of the kernel connecting the layers in the plurality of encoding layers 510 may be set to gradually reduce the dimension of the layers.

For example, each of the plurality of encoding layers 510 sequentially connected from the input layer to which the three-dimensional feature information 410 is inputted may have a dimension that is gradually decreased. According to an embodiment, the code information 520 may have a dimension lower than the three-dimensional feature information 410. For example, when the three-dimensional feature information 410 has a first dimension (e.g., 108*64*64*64), the code information 520 may have a second dimension (e.g., 256*4*4*4) lower than the first dimension. For example, the code information 520 may be referred to as a latent code. According to an embodiment, the plurality of encoding layers 510 may be formed based on a convolution neural network (CNN).

According to an embodiment, the processor 311 may obtain heatmap information 540 based on inputting the code information 520 to a plurality of decoding layers 530. The plurality of decoding layers 530 may include a plurality of layers sequentially connected from an input layer to which the code information 520 is inputted. The layers included in the plurality of decoding layers 530 may be connected by the kernels (or filters) used for the convolution operation. A neural network (or a model) including the plurality of decoding layers 530 being trained (or learned) may include the operation in which the parameters (or the weights) included in the kernels (or the filters) are tuned. A dimension of the input layer of the plurality of decoding layers 530 to which the code information 520 is inputted may be smaller than dimension of an output layer of the plurality of decoding layers 530 from which the heatmap information 540 is outputted. A Dimension of the plurality of decoding layers 530 may be gradually increased. A dimension of the kernel connecting the layers in the plurality of decoding layers 530 may be set to gradually increase the dimension of the layers. For example, each of the plurality of decoding layers 530 sequentially connected from the input layer to which the code information 520 is inputted may have a dimension that is gradually increased. According to an embodiment, the plurality of decoding layers 530 may be formed based on the convolution neural network (CNN). For example, the plurality of encoding layers 510 and the plurality of decoding layers 530 may form an encoder-decoder structure together.

According to an embodiment, the heatmap information 540 may have a dimension higher than the code information 520. For example, when the code information 520 has the second dimension (e.g., 256*4*4*4), the heatmap information 540 may have a third dimension (e.g., 108*64*64*64) higher than the second dimension. For example, the third dimension may be substantially the same as the first dimension, but is not limited thereto. The heatmap information 540 may indicate a probability that vertices 550 corresponding to a body part in a body (e.g., the body 330 of FIG. 3) exists. The vertices 550 may include a three-dimensional coordinate to indicate a location of the body part in the body 330 in a virtual three-dimensional space. For example, the heatmap information 540 may indicate the probability that the vertices 550 corresponding to the body part exists in the virtual three-dimensional space in a form of a heat map.

According to an embodiment, the processor 311 may obtain mesh information 560 based on the heatmap information 540. The mesh information 560 may indicate a shape of the body in the virtual three-dimensional space. The mesh information 560 may include the vertices 550 to indicate the shape of the body. For example, the mesh information 560 may represent the shape of the body 330 including the body part based on meshes in which a plurality of planes formed by interconnecting the vertices 550 are connected. For example, the mesh information 560 may include 108 vertices 550 to represent the shape of the body 330, but is not limited thereto.

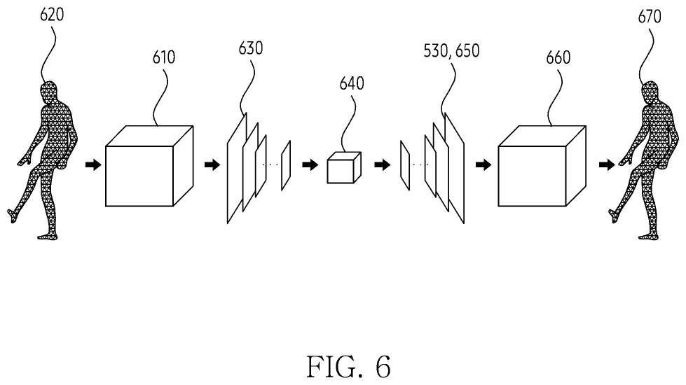

According to an embodiment, before the three-dimensional feature information 410 is inputted, the plurality of encoding layers 510 and the plurality of decoding layers 530 may be learned in advance. A method of learning the plurality of encoding layers 510 and the plurality of decoding layers 530 may be described, for example, through FIG. 6.

FIG. 6 illustrates an example of a method of training a plurality of encoding layers and a plurality of decoding layers according to an embodiment. It will be understood that discussion herein refers to, in some embodiments, to training data.

Referring to FIG. 6, according to an embodiment, a plurality of decoding layers 530 may be trained based on truth heatmap information 610 indicating a probability that a plurality of vertices corresponding to a body part exist. The plurality of decoding layers 530 may be learned based on the truth heatmap information 610 indicating the probability that the plurality of vertices corresponding to the body part exist. The truth heatmap information 610 may be obtained from first truth mesh information 620 including a plurality of vertices that accurately represent a shape of a body in a virtual three-dimensional space. Accurately representing the shape of the body may mean that the shape of the body represented by the plurality of vertices is substantially the same as a shape of a real body, and the corresponding expression may be used equally below unless otherwise stated. The truth heatmap information 610 may indicate a probability that the plurality of vertices included in the first truth mesh information 620 exist.

According to an embodiment, a plurality of pre-encoding layers 630 may output intermediate code information 640 based on receiving the truth heatmap information 610. The plurality of pre-encoding layers 630 may be formed based on a convolutional neural network. The plurality of pre-encoding layers 630 may have a dimension that is gradually decreased. For example, the plurality of pre-encoding layers 630 may have a dimension that is gradually decreased between an input layer receiving the truth heatmap information 610 and an output layer outputting the intermediate code information 640. According to an embodiment, the intermediate code information 640 may have a dimension lower than the truth heatmap information 610. For example, in a case that the truth heatmap information 610 has a first dimension (e.g., 108*64*64*64), the intermediate code information 640 may have a second dimension (e.g., 256*4*4*4) lower than the first dimension.

According to an embodiment, a plurality of pre-decoding layers 650 may output output heatmap information 660 based on receiving the intermediate code information 640. The plurality of pre-decoding layers 650 may be formed based on the convolutional neural network (CNN). The plurality of pre-decoding layers 650 may have a dimension that is gradually increased. For example, the plurality of pre-decoding layers 650 may have a dimension that is gradually decreased between an input layer receiving the intermediate code information 640 and an output layer outputting the output heatmap information 660. According to an embodiment, the output heatmap information 660 may have a dimension higher than the intermediate code information 640. For example, in a case that the intermediate code information 640 has the second dimension (e.g., 256*4*4*4), the output heatmap information 660 may have a third dimension (e.g., 108*64*64*64) higher than the second dimension.

According to an embodiment, second truth mesh information 670 may be obtained from the output heatmap information 660. The second truth mesh information 670 may include vertices to indicate the shape of the body in the virtual three-dimensional space.

According to an embodiment, the plurality of pre-encoding layers 630 and the plurality of pre-decoding layers 650 may be learned such that an error between the truth heatmap information 610 and the output heatmap information 660 is decreased. The plurality of pre-encoding layers 630 and a plurality of pre-decoding layers 650 may be trained such that the error between the truth heatmap information 610 and the output heatmap information 660 is decreased. For example, the error between the truth heatmap information 610 and the output heatmap information 660 may be represented as in Equation 1 below.

$$Loss = {‖ {H}_{out} - {H}_{in} ‖}_{2}^{2} \qquad Equation 1$$

In Equation 1, Hₒᵤₜ may mean the output heatmap information 660 and Hᵢₙ may mean the truth heatmap information 610. As the error between the truth heatmap information 610 and the output heatmap information 660 is minimized, a difference between a shape of the body represented by the first truth mesh information 620 and a posture of the body represented by the second truth mesh information 670 obtained from the output heatmap information 660 may be decreased. As the error between the truth heatmap information 610 and the output heatmap information 660 is minimized, the learning of the plurality of pre-decoding layers 650 may be completed. As the learning of the plurality of pre-decoding layers 650 is completed, the plurality of decoding layers 530 may be formed.

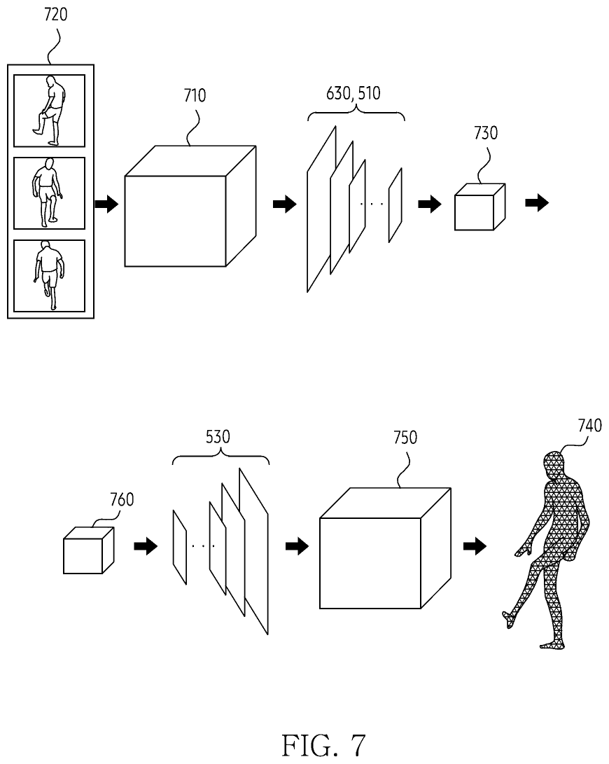

According to an embodiment, since a plurality of encoding layers (e.g., the plurality of encoding layers 510 of FIG. 5) should receive feature information (e.g., the three-dimensional feature information 410 of FIG. 4 and FIG. 5) indicating a probability that a body part exists, the learning of the plurality of pre-encoding layers 630 may not be completed based on the truth heatmap information 610 indicating the probability that the vertices exist. A method of forming the plurality of encoding layers 510 by training the plurality of pre-encoding layers 630 may be described with reference to FIG. 7.

FIG. 7 illustrates an example of a method of training a plurality of encoding layers according to an embodiment.

Referring to FIG. 7, according to an embodiment, a plurality of pre-encoding layers 630 may receive sample feature information 710. The sample feature information 710 may be obtained from a plurality of sample images 720. For example, the sample feature information 710 may indicate a probability that a captured body part exists in the plurality of sample images 720. The sample feature information 710 may indicate the probability that the captured body part exists in the plurality of sample images 720 in a form of a heat map. For example, the sample feature information 710 may be obtained from a backbone network that has received the plurality of sample images 720, but is not limited thereto. According to an embodiment, the plurality of pre-encoding layers 630 may output first sample code information 730 based on receiving the sample feature information 710. The first sample code information 730 may have a dimension lower than the sample feature information 710.

According to an embodiment, sample mesh information 740 may correspond to the plurality of sample images 720. For example, the sample mesh information 740 may include a plurality of vertices that physically accurately represent a shape of a body captured in the plurality of sample images 720 in a virtual three-dimensional space. For example, the sample mesh information 740 may be obtained from the plurality of sample images 720 before learning the plurality of pre-encoding layers 630.

According to an embodiment, sample heatmap information 750 may correspond to the sample mesh information 740. For example, the sample heatmap information 750 may indicate a probability that the plurality of vertices included in the sample mesh information 740 exist in a virtual three-dimensional space. For example, the sample heatmap information 750 may be obtained from the plurality of sample images 720 before training the plurality of pre-encoding layers 630.

According to an embodiment, second sample code information 760 may correspond to the sample heatmap information 750. For example, a plurality of decoding layers 530 may output the sample heatmap information 750 based on receiving the second sample code information 760. For example, the sample heatmap information 750 may be obtained from the plurality of decoding layers 530 that have received the second sample code information 760. For example, the second sample code information 760 may be obtained from the plurality of sample images 720 before learning the plurality of pre-encoding layers 630. For example, the second sample code information 760 may be obtained from the sample heatmap information 750 before learning the plurality of pre-encoding layers 630.

According to an embodiment, a plurality of encoding layers 510 may be obtained as the plurality of pre-encoding layers 630 trained based on truth heatmap information (e.g., truth heatmap information 610 of FIG. 6) are tuned through the sample feature information 710. For example, the plurality of pre-encoding layers 630 may be learned such that an error between the first sample code information 730 and the second sample code information 760 is decreased. The plurality of pre-encoding layers 630 may be trained such that the error between the first sample code information 730 and the second sample code information 760 is decreased. For example, the error between the first sample code information 730 and the second sample code information 760 may be represented as in Equation 2.

$$Loss = {‖ {C}_{pred} - {C}_{gt} ‖}_{1} \qquad Equation 2$$

In Equation 2, C_{pred} may indicate the second sample code information 760, and C_{gt} may indicate the first sample code information 730. As the error between the first sample code information 730 and the second sample code information 760 is minimized, the learning of the plurality of pre-encoding layers 630 may be completed. As the learning of the plurality of pre-encoding layers 630 is completed, the plurality of encoding layers 510 may be formed.

As described above, an electronic device (e.g., the electronic device 310 of FIG. 3) according to an embodiment may provide a method of accurately reconstructing the shape of the body captured in the plurality of images in the virtual three-dimensional space by the plurality of encoding layers 510 learned through the plurality of vertices that accurately represent the shape of the body in the three-dimensional space. The electronic device (e.g., the electronic device 310 of FIG. 3) according to an embodiment may provide a method of accurately reconstructing the shape of the body captured in the plurality of images in the virtual three-dimensional space by a plurality of decoding layers (e.g., the plurality of decoding layers 530 of FIG. 5) learned through the plurality of vertices that accurately represent the shape of the body in the three-dimensional space.

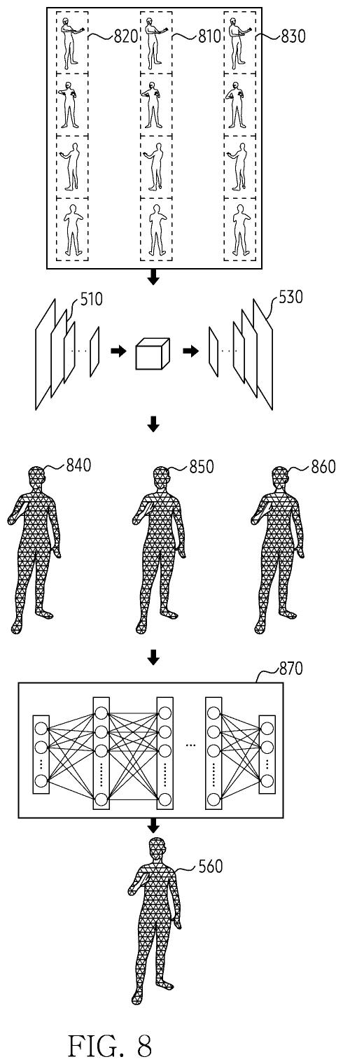

FIG. 8 illustrates an example of a method for an electronic device to obtain mesh information from a plurality of images obtained at different timings, according to an embodiment.

Referring to FIG. 8, according to an embodiment, a processor (e.g., the processor 311 of FIG. 3) may obtain a plurality of first images 810, a plurality of second images 820, and/or a plurality of third images 830 captured at different timings. For example, the processor 311 may obtain the plurality of first images 810, the plurality of second images 820, and the plurality of third images 830 from a plurality of cameras (e.g., the first camera 314 and/or the one or more second cameras 320 of FIG. 3). The plurality of first images 810 may be obtained from the plurality of cameras at a first timing. The plurality of second images 820 may be obtained from the plurality of cameras at a second timing before the first timing. The plurality of third images 830 may be obtained from the plurality of cameras at a third timing after the first timing. According to an embodiment, a shape of a body 330 captured in the plurality of first images 810, the plurality of second images 820, and the plurality of third images 830 may differ from each other. For example, a shape of the body 330 captured in the plurality of first images 810 may differ from a shape of the body 330 captured in the plurality of second images 820. For example, the shape of the body 330 captured in the plurality of first images 810 may differ from a shape of the body 330 captured in the plurality of third images 830. For example, the shape of the body 330 captured in the plurality of second images 820 may differ from the shape of the body 330 captured in the plurality of third images 830. However, it is not limited thereto. For example, the shape of the body 330 captured in the plurality of first images 810, the plurality of second images 820, and the plurality of third images 830 may be substantially the same as each other.

According to an embodiment, the processor 311 may obtain first mesh information 840 to indicate the shape of the body 330 captured in the plurality of first images 810 in a virtual three-dimensional space from the plurality of first images 810 obtained at the first timing through a plurality of encoding layers 510 and a plurality of decoding layers 530. The first mesh information 840 may include vertices to represent the shape of the body 330 in the virtual three-dimensional space. According to an embodiment, the processor 311 may obtain second mesh information 850 to indicate the shape of the body 330 captured in the plurality of second images 820 in the virtual three-dimensional space from the plurality of second images 820 obtained at the second timing through the plurality of encoding layers 510 and the plurality of decoding layers 530. The second mesh information 850 may include vertices to represent the shape of the body 330 in the virtual three-dimensional space. According to an embodiment, the processor 311 may obtain third mesh information 860 to indicate the shape of the body 330 captured in the plurality of third images 830 in the virtual three-dimensional space from the plurality of third images 830 obtained at the third timing through the plurality of encoding layers 510 and the plurality of decoding layers 530. The third mesh information 860 may include vertices to represent the shape of the body 330 in the virtual three-dimensional space.

According to an embodiment, the processor 311 may input at least a portion of the first mesh information 840 obtained from the plurality of first images 810, the second mesh information 850 obtained from the plurality of second images 820 at the second timing before the first timing, and the third mesh information 860 obtained from the plurality of third images 830 after the first timing, to temporal layers 870. For example, the temporal layers 870 may include a 1D-temporal convolution neural network. For example, the processor 311 may obtain weights respectively corresponding to the first mesh information 840 and the second mesh information 850 based on inputting the first mesh information 840 and the second mesh information 850 to the temporal layers 870. For example, the processor 311 may obtain weights respectively corresponding to the first mesh information 840, the second mesh information 850, and the third mesh information 860 based on inputting the first mesh information 840, the second mesh information 850, and the third mesh information 860 to the temporal layers 870. For example, the processor 311 may obtain first weights corresponding to each of a plurality of vertices included in the first mesh information 840 based on inputting the plurality of vertices included in the first mesh information 840 to the temporal layers 870. For example, the processor 311 may obtain second weights corresponding to each of a plurality of vertices included in the second mesh information 850 based on inputting the plurality of vertices included in the second mesh information 850 to the temporal layers 870. For example, the processor 311 may obtain third weights corresponding to each of a plurality of vertices included in the third mesh information 860 based on inputting the plurality of vertices included in the third mesh information 860 to the temporal layers 870. For example, a method of obtaining the weights from the first mesh information 840 and the second mesh information 850 by the processor 311 may be referred to as a self-attention method.

According to an embodiment, the processor 311 may obtain mesh information 560 based on combining the first mesh information 840 and the second mesh information 850 through the weights respectively corresponding to the first mesh information 840 and the second mesh information 850. For example, the mesh information 560 obtained through the combination of the first mesh information 840 and the second mesh information 850 may indicate the shape of the body 330 at the first timing at which the plurality of first images 810 are captured in the three-dimensional virtual space. The processor 311 may obtain the mesh information 560 based on combining the first mesh information 840, the second mesh information 850, and the third mesh information 860 through the weights respectively corresponding to the first mesh information 840, the second mesh information 850, and the third mesh information 860. For example, the mesh information 560 obtained through the combination of the first mesh information 840, the second mesh information 850, and the third mesh information 860 may indicate the shape of the body 330 at the first timing at which the plurality of first images 810 are captured in the three-dimensional virtual space. For example, the processor 311 may combine the first mesh information 840 and the second mesh information 850 through the first weights corresponding to the first mesh information 840, and the second weights corresponding to the second mesh information 850. For example, the processor 311 may combine the first mesh information 840, the second mesh information 850, and the third mesh information 860 through the first weights corresponding to the first mesh information 840, the second weights corresponding to the second mesh information 850, and the third weights corresponding to the third mesh information 860. For example, a method of combining the first mesh information 840, the second mesh information 850, and the third mesh information 860 by the processor 311 may be represented as in Equation 3 below.

$${V}_{m} = {\sum }_{i = 1}^{n} {d}_{i} ⊙ {V}_{i} \qquad Equation 3$$

In Equation 3, Vₘ may indicate the mesh information 560, dᵢ may indicate the weights respectively corresponding to the first mesh information 840, the second mesh information 850, and the third mesh information 860, Vᵢ may indicate the first mesh information 840, the second mesh information 850, and the third mesh information 860, and ⊙ may indicate an element-wise product operator of a vector. For example, the method of combining the first mesh information 840, the second mesh information 850, and the third mesh information 860 by the processor 311 may be referred to as a temporal smoothing method. As the mesh information 560 is obtained by reflecting a timing at which the plurality of images 810, 820, and 830 are captured, accuracy of the shape of the body 330 represented from the mesh information 560 may increase.

As described above, since the mesh information 560 is obtained by reflecting the timing at which the plurality of images 810, 820, and 830 are obtained, the electronic device (e.g., the electronic device 310 of FIG. 3) according to an embodiment may provide a method of accurately reconstructing the shape of the body 330 in the virtual three-dimensional space. Since the mesh information 560 is obtained by reflecting the timing at which the plurality of images 810, 820, and 830 are obtained, the electronic device 310 according to an embodiment may provide a method of reconstructing the shape of the body 330 to have temporal consistency.

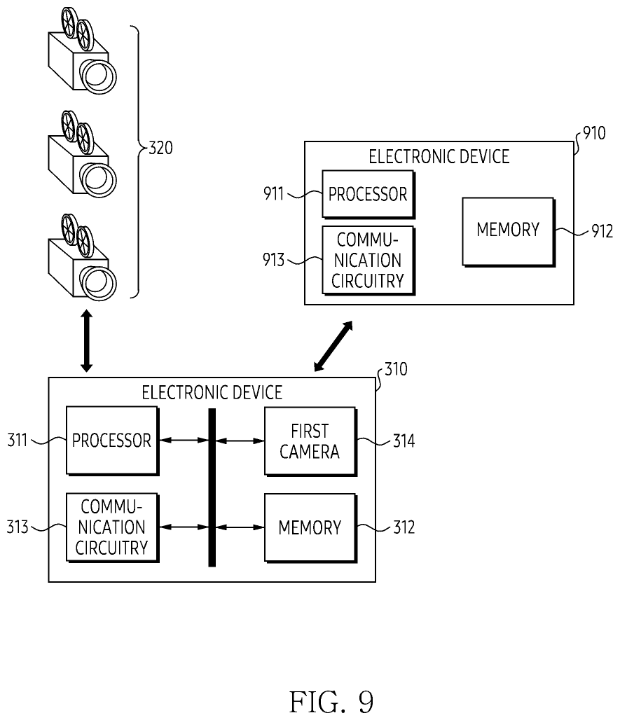

FIG. 9 illustrates an example of an environment including an electronic device according to an embodiment.

Referring to FIG. 9, according to an embodiment, another electronic device 910 may include a processor 911, memory 912, and/or communication circuitry 913. The processor 911 of FIG. 9 may be substantially the same as the processor 102 and/or the processor 152 of FIG. 1, the memory 912 of FIG. 9 may be substantially the same as the memory 104 and/or the memory 154 of FIG. 1, and the communication circuitry 913 of FIG. 9 may be substantially the same as the communication interface 158 of FIG. 1, so that a redundant description will be omitted. According to an embodiment, the other electronic device 910 may be located outside an electronic device 310. The other electronic device 910 may be capable of communicating with the electronic device 310 through the communication circuitry 913 in the other electronic device 910.

According to an embodiment, a processor 311 of the electronic device 310 may obtain a plurality of images (e.g., the plurality of images 341, 342, 343, and 344 of FIG. 3) in which a body part is captured, from a first camera 314 and one or more second cameras 320 connected through communication circuitry 313. The processor 311 may obtain feature information (e.g., the three-dimensional feature information 410 of FIG. 4 and FIG. 5) indicating a probability that the body part exists, from the plurality of images 341, 342, 343, and 344. The processor 311 may obtain code information (e.g., the code information 520 of FIG. 5) with respect to the body part based on inputting the three-dimensional feature information 410 to a plurality of encoding layers (e.g., the plurality of encoding layers 510 of FIG. 5). The processor 311 may transmit the code information 520 to another electronic device 910 outside the electronic device 310 through the communication circuitry 313. Since the code information 520 is obtained by inputting the plurality of images 341, 342, 343, and 344 and/or the feature information to the plurality of encoding layers, a size (or a capacity) of the code information 520 may be smaller than a size (or a capacity) of the plurality of images 341, 342, 343, and 344 and the feature information. Since the code information 520 having a relatively small size is transmitted, an amount of information exchanged between the electronic device 310 and the other electronic device 910 may be decreased. Based on the decrease in the amount of the information, the electronic device 310 and the other electronic device 910 may decrease a bandwidth of a network.

According to an embodiment, the processor 911 of the other electronic device 910 may obtain heatmap information (e.g., the heatmap information 540 of FIG. 5) based on inputting the code information 520 to a plurality of decoding layers (e.g., the plurality of decoding layers 530 of FIG. 5). The processor 911 may transmit the heatmap information 540 to the electronic device 310 through the communication circuitry 913. According to an embodiment, the electronic device 310 may receive the heatmap information 540 through the communication circuitry 313. The electronic device 310 may obtain mesh information (e.g., the mesh information 560 of FIG. 5) to indicate a shape of a body in a virtual three-dimensional space based on the heatmap information 540 received through the communication circuitry 313. However, it is not limited thereto. For example, the processor 911 of the other electronic device 910 may obtain the mesh information (e.g., the mesh information 560 of FIG. 5) to indicate the shape of the body in the virtual three-dimensional space based on obtaining the heatmap information 540. In a case that the processor 911 of the other electronic device 910 obtains the mesh information 560 from the heatmap information 540, the processor 911 of the other electronic device 910 may transmit the mesh information 560 to the electronic device 310 through the communication circuitry 913.

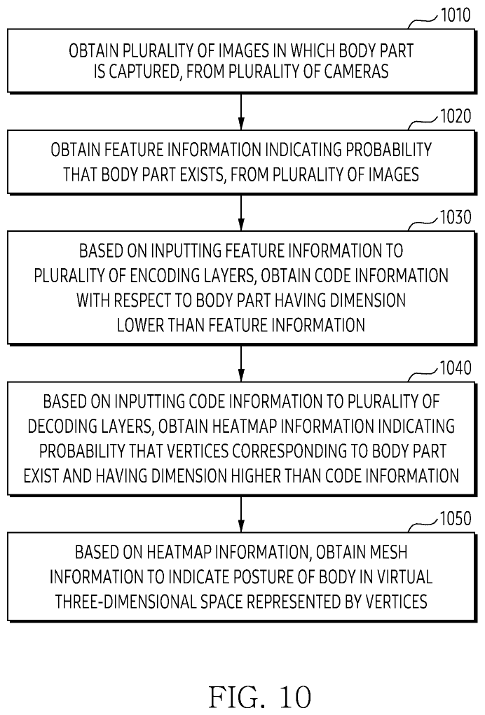

FIG. 10 is a flowchart for describing an operation of an electronic device according to an embodiment.

The operation illustrated in FIG. 10 may be performed by the electronic device 310 illustrated in FIG. 3.

Referring to FIG. 10, in operation 1010, a processor (e.g., the processor 311 of FIG. 3) may obtain a plurality of images (e.g., the plurality of images 341, 342, 343, and 344) in which a body part is captured from a plurality of cameras. For example, the plurality of images 341, 342, 343, and 344 may be obtained by a first camera (e.g., the first camera 314 of FIG. 3) and one or more second cameras (e.g., the one or more second cameras 320 of FIG. 3). According to an embodiment, the plurality of images 341, 342, 343, and 344 may include at least a portion of a body (e.g., the body 330 of FIG. 3) captured at different viewpoints. For example, the plurality of images 341, 342, 343, and 344 may be obtained by the first camera 314 and the one or more second cameras 320 directing the body 330 from different angles.

In operation 1020, the processor 311 may obtain feature information (e.g., the three-dimensional feature information 410 of FIG. 4 and FIG. 5) indicating a probability that a body part of the body 330 exists, from the plurality of images 341, 342, 343, and 344. The processor 311 may obtain two-dimensional feature information (e.g., the two-dimensional feature information 420 of FIG. 4) indicating a probability that a body part exists in a virtual two-dimensional space, from the plurality of images 341, 342, 343, and 344. For example, the processor 311 may obtain the two-dimensional feature information 420 based on inputting the plurality of images 341, 342, 343, and 344 to a backbone network. The processor 311 may be configured to obtain the three-dimensional feature information 410 to indicate a probability that a body part exists in a virtual three-dimensional space by unprojecting the two-dimensional feature information 420 onto the virtual three-dimensional space. For example, the processor 311 may obtain the three-dimensional feature information 410 from the two-dimensional feature information 420 through an algorithm for unprojecting the two-dimensional feature information 420 onto the virtual three-dimensional space. For example, the processor 311 may obtain the three-dimensional feature information 410 from the two-dimensional feature information 420 through a trained neural network.

In operation 1030, the processor 311 may obtain code information (e.g., the code information 520 of FIG. 5) with respect to a body part having a dimension lower than the three-dimensional feature information 410 based on inputting the three-dimensional feature information 410 to a plurality of encoding layers (e.g., the plurality of encoding layers 510 of FIG. 5). For example, the plurality of encoding layers 510 may be formed based on a convolution neural network.

In operation 1040, the processor 311 may obtain heatmap information 540 indicating a probability that vertices (e.g., the vertices 550 of FIG. 5) corresponding to a body part exist and having a dimension higher than the code information 520 based on inputting the code information 520 to a plurality of decoding layers (e.g., the plurality of decoding layers 530 of FIG. 5). For example, the decoding layers 530 may be formed based on a convolution neural network.

In operation 1050, the processor 311 may obtain mesh information (e.g., the mesh information 560 of FIG. 5) to indicate a shape of the body 330 in the virtual three-dimensional space represented by the vertices 550 based on the heatmap information 540. The mesh information 560 may represent the shape of the body 330 including a body part based on meshes in which a plurality of planes formed by interconnecting the vertices 550 are connected.

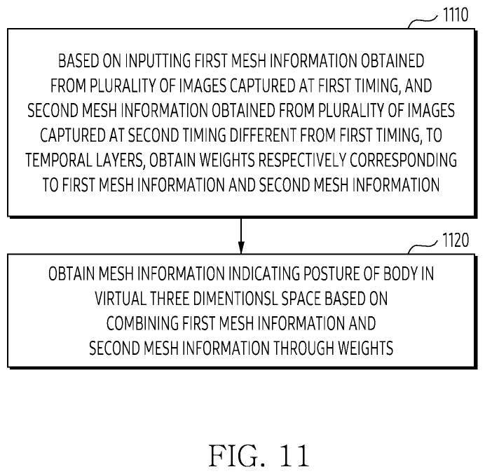

FIG. 11 is a flowchart for describing an operation of an electronic device according to an embodiment.

The operation illustrated in FIG. 11 may be performed by the electronic device 310 illustrated in FIG. 3. For example, the operation of FIG. 11 may be included in the operation 1050 of FIG. 10.

Referring to FIG. 11, in operation 1110, a processor (e.g., the processor 311 of FIG. 3) may obtain, based on inputting first mesh information (e.g., the first mesh information 840 of FIG. 8) obtained from a plurality of images (e.g., the plurality of first images 810 of FIG. 8) captured at a first timing, and second mesh information (e.g., the second mesh information 850 of FIG. 8) obtained from a plurality of images (e.g., the plurality of second images 820 of FIG. 8) captured at a second timing different from the first timing, to temporal layers (e.g., the temporal layers 870 of FIG. 8), weights respectively corresponding to the first mesh information and the second mesh information. For example, the second timing may be before the first timing, but is not limited thereto. For example, the second timing may be after the first timing. The processor 311 may obtain the first mesh information 840 to indicate a shape (e.g., a posture) of a body captured in the plurality of first images 810 in a virtual three-dimensional space from a plurality of first images 810 obtained at the first timing through a plurality of encoding layers (e.g., the plurality of encoding layers 510 of FIG. 5) and a plurality of decoding layers (e.g., the plurality of decoding layers 530 of FIG. 5). The processor 311 may obtain the second mesh information 850 to indicate a shape of the body captured in the plurality of second images 820 in the virtual three-dimensional space from the plurality of second images 820 obtained at the second timing through the plurality of encoding layers 510 and the plurality of decoding layers 530.

According to an embodiment, the processor 311 may obtain the weights respectively corresponding to the first mesh information 840 and the second mesh information 850 based on inputting the first mesh information 840 and the second mesh information 850 to the temporal layers 870. For example, the temporal layers 870 may include a 1D-temporal convolution neural network. For example, the processor 311 may obtain first weights corresponding to each of a plurality of vertices included in the first mesh information 840 based on inputting the plurality of vertices included in the first mesh information 840 to the temporal layers 870. For example, the processor 311 may obtain second weights corresponding to each of a plurality of vertices in the second mesh information 850 based on inputting the plurality of vertices included in the second mesh information 850 to the temporal layers 870. A method of obtaining the weights from the first mesh information 840 and the second mesh information 850 by the processor 311 may be referred to as a self-attention method.

In operation 1120, the processor 311 may obtain mesh information (e.g., the mesh information 560 of FIG. 5) to indicate a posture of the body in the virtual three-dimensional space based on combining the first mesh information 840 and the second mesh information 850 through the weights. For example, the processor 311 may obtain the mesh information 560 by combining the first mesh information 840 and the second mesh information 850 through the first weights obtained from the first mesh information 840 and the second weights obtained from the second mesh information 850. For example, a method of combining the first mesh information 840 and the second mesh information 850 by the processor 311 may be referred to as a temporal smoothing method. For example, the mesh information 850 may indicate the shape (e.g., the posture) of the body captured in the plurality of first images 810 at the first timing in the virtual three-dimensional space. As the mesh information 560 to indicate the shape of the body captured at the first timing within a virtual three-dimensional space is obtained based on the first mesh information 840 obtained from the plurality of first images 810 at the first timing and the second mesh information 850 obtained from the plurality of second images 830 at the second timing different from the first timing, the electronic device (e.g., the electronic device 310 of FIG. 3) according to an embodiment may provide a method of reconstructing the shape of the body to have temporal consistency.

According to an embodiment, an electronic device (e.g., the electronic device 310 of FIG. 3) may comprise communication circuitry (e.g., the communication circuitry 313 of FIG. 3) and a processor (e.g., the processor 311 of FIG. 3). According to an embodiment, the processor may obtain a plurality of images (e.g., the plurality of images 341, 342, 343, and 344 of FIG. 3) in which a body part is captured, from a plurality of cameras (e.g., the first camera 314 and/or the one or more second cameras 320 of FIG. 3) using the communication circuitry. According to an embodiment, the processor may obtain feature information (e.g., the three-dimensional feature information 410 of FIG. 4) indicating a probability of which the body part exists, from the plurality of images. According to an embodiment, the processor may, based on inputting the feature information to a plurality of encoding layers (e.g., the plurality of encoding layers 510 of FIG. 5), obtain code information (e.g., the code information 520 of FIG. 5) with respect to the body part having a dimension lower than the feature information. According to an embodiment, the processor may, based on inputting the code information to a plurality of decoding layers (e.g., the plurality of decoding layers 530 of FIG. 5), obtain heatmap information (e.g., the heatmap information 540 of FIG. 5) indicating a probability that vertices (e.g., the vertices 550 of FIG. 5) corresponding to the body part exist and having a dimension higher than the code information. According to an embodiment, the processor may be configured to obtain mesh information (e.g., the mesh information 560 of FIG. 5) to indicate a shape of a body in a virtual three-dimensional space that is represented by the vertices based on the heatmap information.

According to an embodiment, the plurality of decoding layers may be trained based on truth heatmap information (e.g., the truth heatmap information 610 of FIG. 6) indicating a probability that the plurality of vertices corresponding to the body part exist.

According to an embodiment, the plurality of encoding layers may be obtained as encoding layers (e.g., the plurality of pre-encoding layers 630 of FIG. 6) trained based on the truth heatmap information (e.g., the truth heatmap information 610 of FIG. 6) are tuned through other feature information (e.g., the sample feature information 710 of FIG. 6) indicating a probability that a body part exists.

According to an embodiment, the processor may be configured to, based on inputting first mesh information (e.g., the first mesh information 840 of FIG. 8) obtained from a plurality of images (e.g., the plurality of first images 810 of FIG. 8) captured at a first timing, and second mesh information (e.g., the second mesh information 850 of FIG. 8) obtained from a plurality of images (e.g., the plurality of second images 820 of FIG. 8) at a second timing different from the first timing, to temporal layers, obtain weights respectively corresponding to the first mesh information and the second mesh information, and obtain the mesh information based on combining the first mesh information and the second mesh information through the weights.

According to an embodiment, the second timing may be before the first timing. According to an embodiment, the processor may be configured to, based on inputting the first mesh information, the second mesh information, and third mesh information (e.g., the third mesh information 860 of FIG. 8) obtained from a plurality of images (e.g., the plurality of third images 830 of FIG. 8) at a third timing after the first timing, to the temporal layers, obtain weights respectively corresponding to the first mesh information, the second mesh information, and the third mesh information, and obtain the mesh information, based on combining the first mesh information, the second mesh information, and the third mesh information through the weights.

According to an embodiment, the processor may obtain two-dimensional feature information (e.g., the two-dimensional feature information 420 of FIG. 4) used to obtain the feature information which is three-dimensional feature information from each of the plurality of images using a backbone network. The two-dimensional feature information may include a probability distribution indicating a probability that the body part exists in the plurality of images.

According to an embodiment, the processor may be configured to obtain second feature information (e.g., the two-dimensional feature information 420 of FIG. 4) that is different from the feature information which is first feature information and indicates a probability that the body part exists in a virtual two-dimensional space, and obtain the first feature information to indicate a probability that the body part exists in the virtual three-dimensional space by unprojecting the second feature information onto the virtual three-dimensional space.

According to an embodiment, the mesh information may represent the shape of a user including the body part based on meshes in which a plurality of planes formed by interconnecting the vertices are connected.

According to an embodiment, each of the plurality of encoding layers, which are sequentially connected from an input layer to which the feature information is inputted, may have a dimension that is gradually decreased from the input layer, and each of the plurality of decoding layers, which are sequentially connected from an input layer to which the code information is inputted, may have a dimension that is gradually increased from the input layer connected to the plurality of decoding layers.

According to an embodiment, each of the plurality of images may be obtained from the first camera and the one or more second cameras directing the body from different angles.

According to an embodiment, an operation method of an electronic device may comprise obtaining a plurality of images (e.g., the plurality of images 341, 342, 343, and 344 of FIG. 3) in which a body part is captured, from a plurality of cameras (e.g., the first camera 314 and/or the one or more second cameras 320 of FIG. 3). According to an embodiment, the method may comprise obtaining feature information (e.g., the three-dimensional feature information 410 of FIG. 4) indicating a probability of which the body part exists, from the plurality of images. According to an embodiment, the method may comprise obtaining code information (e.g., the code information 520 of FIG. 5) with respect to the body part having a dimension lower than the feature information based on inputting the feature information to a plurality of encoding layers (e.g., the plurality of encoding layers 510 of FIG. 5). According to an embodiment, the method may comprise obtaining heatmap information (e.g., the heatmap information 540 of FIG. 5) indicating a probability that vertices (e.g., the vertices 550 of FIG. 5) corresponding to the body part exist and having a dimension higher than the code information based on inputting the code information to a plurality of decoding layers. According to an embodiment, the method may comprise obtaining mesh information (e.g., the mesh information 560 of FIG. 5) to indicate a shape of a body in a virtual three-dimensional space that is represented by the vertices based on the heatmap information.

According to an embodiment, the plurality of encoding layers may be obtained as encoding layers trained based on the truth heatmap information are tuned through other feature information indicating a probability that a body part exists.

According to an embodiment, the method may comprise, based on inputting first mesh information (e.g., the first mesh information 840 of FIG. 8) obtained from a plurality of images (e.g., the plurality of first images 810 of FIG. 8) captured at a first timing, and second mesh information (e.g., the second mesh information 850 and/or the third mesh information 860 of FIG. 8) obtained from a plurality of images (e.g., the plurality of second images 820 and/or the plurality of third images 830 of FIG. 8) at a second timing different from the first timing, to temporal layers, obtaining weights respectively corresponding to the first mesh information and the second mesh information, and obtaining the mesh information, based on combining the first mesh information and the second mesh information through the weights.

According to an embodiment, the method may comprise obtaining two-dimensional feature information used to obtain the feature information which is three-dimensional feature information from each of the plurality of images using a backbone network. According to an embodiment, the two-dimensional feature information may include a probability distribution indicating a probability that the body part exists in the plurality of images.

According to an embodiment, the second timing may be before the first timing, and the method may comprise, based on inputting the first mesh information, the second mesh information, and a third mesh information (e.g., the third mesh information 860 of FIG. 8) obtained from a plurality of images (e.g., the plurality of third images 830 of FIG. 8) at a third timing after the first timing, to the temporal layers, obtaining weights respectively corresponding to the first mesh information, the second mesh information, and the third mesh information, and obtaining the mesh information, based on combining the first mesh information, the second mesh information, and the third mesh information through the weights.

According to an embodiment, the method may comprise obtaining second feature information (e.g., the two-dimensional feature information 420 of FIG. 4) that is different from the feature information which is first feature information and indicates a probability that the body part exists in a virtual two-dimensional space, and obtaining the first feature information to indicate a probability that the body part exists in the virtual three-dimensional space by unprojecting the second feature information onto the virtual three-dimensional space.

According to an embodiment, the mesh information may indicate the shape of the body based on meshes in which a plurality of planes formed by interconnecting the vertices are connected.

According to an embodiment, each of the plurality of encoding layers, which are sequentially connected from an input layer to which the feature information is inputted, may have a dimension that is gradually decreased from the input layer, and each of the plurality of decoding layers, which are sequentially connected from an input layer to which the code information is inputted, may have a dimension that is gradually increased from the input layer connected to the plurality of decoding layers.

According to an embodiment, each of the plurality of images may be respectively obtained from the plurality of cameras directing the body from different angles.

According to an embodiment, a computer-readable storage medium may store one or more programs. According to an embodiment, the one or more programs, when executed by the at least one processor of an electronic device, may store instructions to cause the electronic device to obtain a plurality of images (e.g., the plurality of images 341, 342, 343, and 344 of FIG. 3) in which a body part is captured, from a first camera (e.g., the first camera 314 of FIG. 3) and one or more second cameras (e.g., the one or more second cameras 320 of FIG. 3) connected through communication circuitry (e.g., the communication circuitry 313 of FIG. 3). According to an embodiment, the one or more programs, when executed by the at least one processor of the electronic device, may store instructions to cause the electronic device to obtain feature information (e.g., the three-dimensional feature information 410 of FIG. 4) indicating a probability of which the body part exists, from the plurality of images. According to an embodiment, the one or more programs, when executed by the at least one processor of the electronic device, may store instructions to cause the electronic device to obtain code information (e.g., the code information 520 of FIG. 5) with respect to the body part having a dimension lower than the feature information, based on inputting the feature information to a plurality of encoding layers (e.g., the plurality of encoding layers 510 of FIG. 5). According to an embodiment, the one or more programs, when executed by the at least one processor of the electronic device, may store instructions to cause the electronic device to transmit the code information to an external electronic device through the communication circuitry. According to an embodiment, the one or more programs, when executed by the at least one processor of the electronic device, may store instructions to cause the electronic device to receive, from the external electronic device through the communication circuitry, heatmap information (e.g., the heatmap information 540 of FIG. 5) indicating a probability that vertices (e.g., the vertices 550 of FIG. 5) corresponding to the body part exist and having a dimension higher than the code information. According to an embodiment, the one or more programs, when executed by the at least one processor of the electronic device, may store instructions to cause the electronic device to obtain mesh information (e.g., the mesh information 560 of FIG. 5) to indicate a shape of a body in a virtual three-dimensional space that is represented by the vertices based on the heatmap information.

According to an embodiment, the one or more programs, when executed by the at least one processor of the electronic device, may store instructions to cause the electronic device to, based on inputting first mesh information (e.g., the first mesh information 840 of FIG. 8) obtained from a plurality of images (e.g., the plurality of first images 810 of FIG. 8) captured at a first timing, and second mesh information (e.g., the second mesh information 850 and/or the third mesh information 860 of FIG. 8) obtained from a plurality of images (e.g., the plurality of second images 820 and/or the plurality of third images 830 of FIG. 8) at a second timing different from the first timing, to temporal layers, obtain weights respectively corresponding to the first mesh information and the second mesh information, and obtain the mesh information, based on combining the first mesh information and the second mesh information through the weights.

The electronic device according to various embodiments may be one of various types of electronic devices. The electronic devices may include, for example, a portable communication device (e.g., a smartphone), a computer device, a portable multimedia device, a portable medical device, a camera, an electronic device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium (e.g., internal memory or external memory) that is readable by a machine (e.g., the electronic device). For example, a processor of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry; and
at least one processor comprising circuitry, wherein the at least one processor is configured to:
obtain, from the communication circuitry and using a plurality of cameras, a plurality of images in which at least a part of a body is captured;
obtain feature information associated with the plurality of images, the feature information indicating a first probability that a body part is present in the plurality of images;
obtain, based on the feature information being input into a plurality of encoding layers, code information associated with the body part having one or more dimensions smaller than one or more dimensions associated with the feature information;
obtain, based on the code information being input into a plurality of decoding layers, heatmap information indicating a second probability that one or more vertices corresponding to the body part exist, the second probability also indicating that the body part has one or more dimensions greater than one or more dimensions associated with the code information; and
obtain mesh information that indicates a shape of the body in a virtual three-dimensional space, the mesh information comprising being based on the one or more vertices.

2. The electronic device of claim 1, wherein the plurality of decoding layers are trained based on truth heatmap information associated with training data, the truth heatmap information indicating a probability that a plurality of vertices corresponding to a body part exist in the training data.

3. The electronic device of claim 1, wherein the plurality of encoding layers are obtained based on training using on truth heatmap information and fine-tuned using training feature information indicating a probability that a body part exists.

4. The electronic device of claim 1, wherein the at least one processor is further configured to:
based on first mesh information and second mesh information being input into one or more temporal layers, obtain a plurality of weights corresponding to the first mesh information and the second mesh information, wherein the first mesh information is obtained from a first plurality of images captured at a first time, and wherein the second mesh information obtained from a second plurality of images captured at a second time different from the first time; and
obtain the mesh information based on a combination of the first mesh information and the second mesh information according to the plurality of weights.

5. The electronic device of claim 1, wherein the feature information is three-dimensional feature information, and wherein the at least one processor is further configured to:
obtain two-dimensional feature information from each of the plurality of images using a backbone network, wherein the two-dimensional feature information is associated with the three-dimensional feature information, and
wherein the two-dimensional feature information comprises a probability distribution indicating a probability that the body part exists in the plurality of images.

6. The electronic device of claim 1, wherein the feature information is first feature information, and wherein the at least one processor is further configured to:
obtain, from the plurality of images, second feature information that is different from the first feature information, the second feature information indicating a probability that the body part exists in a virtual two-dimensional space; and
obtain the first feature information indicating a probability that the body part exists in the virtual three-dimensional space by unprojecting the second feature information onto the virtual three-dimensional space.

7. The electronic device of claim 1, wherein the mesh information comprises information about meshes in which a plurality of planes formed by interconnecting the one or more vertices are connected.

8. The electronic device of claim 1, wherein each of the plurality of encoding layers are sequentially connected from a first input layer, the first input layer being one where the feature information is input, and wherein each of the plurality of encoding layers is configured for dimensions that are gradually reduced from the first input layer, and
wherein each of the plurality of decoding layers are sequentially connected from a second input layer to which the code information is input, and wherein each of the plurality of decoding layers are configured for dimensions that gradually increase from the second input layer connected to the plurality of decoding layers.

9. The electronic device of claim 1, wherein the plurality of images are obtained from the plurality of cameras capturing the body from different angles.

10. A method for identifying a body part in images, the method being executed by one or more processors of an electronic device, the method comprising:
obtaining a plurality of images in which at least part of a body is captured;
obtaining feature information associated with the plurality of images, the feature information indicating a first probability that a body part is present in the plurality of images;
obtaining, based on the feature information being input into a plurality of encoding layers, code information associated with the body part having one or more dimensions smaller than one or more dimensions associated with the feature information;
obtaining, based on the code information being input into a plurality of decoding layer, heatmap information indicating a second probability that one or more vertices corresponding to the body part exist, the second probability also indicating that the body part has one or more dimensions greater than one or more dimensions associated with the code information the code information; and
obtaining mesh information that indicates a shape of the body in a virtual three-dimensional space, the mesh information comprising being based on the one or more vertices.

11. The method of claim 10, wherein the plurality of decoding layers are trained based on truth heatmap information associated with training data, the truth heatmap information indicating a probability that a plurality of vertices corresponding to a body part exist in the training data.

12. The method of claim 10, wherein the plurality of encoding layers are obtained based on training using on truth heatmap information and fine-tuned using training feature information indicating a probability that a body part exists.

13. The method of claim 10, further comprising:
based on first mesh information and second mesh information being input into one or more temporal layers, obtaining a plurality of weights corresponding to the first mesh information and the second mesh information, wherein the first mesh information is obtained from a first plurality of images captured at a first time, and wherein the second mesh information obtained from a second plurality of images captured at a second time different from the first time; and
obtaining the mesh information based on a combination of the first mesh information and the second mesh information according to the plurality of weights.

14. The method of claim 13, wherein the feature information is three-dimensional feature information, and the method further comprises:
obtaining two-dimensional feature information from each of the plurality of images using a backbone network, wherein the two-dimensional feature information is associated with the three-dimensional feature information, and
wherein the two-dimensional feature information comprises a probability distribution indicating a probability that the body part exists in the plurality of images.

15. The method of claim 10, the feature information is first feature information, and wherein the method further comprises:
obtaining, from the plurality of images, second feature information that is different from the first feature information, the second feature information indicating a probability that the body part exists in a virtual two-dimensional space; and
obtaining the first feature information indicating a probability that the body part exists in the virtual three-dimensional space by unprojecting the second feature information onto the virtual three-dimensional space.

16. The method of claim 10, wherein the mesh information comprises information about meshes in which a plurality of planes formed by interconnecting the one or more vertices are connected.

17. The method of claim 10, wherein each of the plurality of encoding layers are sequentially connected from a first input layer, the first input layer being one where the feature information is input, and wherein each of the plurality of encoding layers is configured for dimensions that are gradually reduced from the first input layer, and
wherein each of the plurality of decoding layers are sequentially connected from a second input layer to which the code information is input, and wherein each of the plurality of decoding layers are configured for dimensions that gradually increase from the second input layer connected to the plurality of decoding layers.

18. The method of claim 10, wherein the plurality of images is obtained from a plurality of cameras capturing the body from different angles.

19. A computer readable storage medium storing one or more instructions, wherein the one or more instructions, when executed by at least one processor of an electronic device, cause the electronic device to:
obtain, from the communication circuitry and using a plurality of cameras, a plurality of images in which at least a part of a body is captured;
obtain feature information associated with the plurality of images, the feature information indicating a first probability that a body part is present in the plurality of images;
obtain, based on the feature information being input into a plurality of encoding layers, code information associated with the body part having one or more dimensions smaller than one or more dimensions associated with the feature information;
obtain, based on the code information being input into a plurality of decoding layers, heatmap information indicating a second probability that one or more vertices corresponding to the body part exist, the second probability also indicating that the body part has one or more dimensions greater than one or more dimensions associated with the code information; and
obtain mesh information that indicates a shape of the body in a virtual three-dimensional space, the mesh information comprising being based on the one or more vertices.

20. The computer readable storage medium of claim 19, wherein the one or more instructions, when executed by at least one processor of an electronic device, further cause the electronic device to:
based on first mesh information and second mesh information being input into one or more temporal layers, obtain a plurality of weights corresponding to the first mesh information and the second mesh information, wherein the first mesh information is obtained from a first plurality of images captured at a first time, and wherein the second mesh information obtained from a second plurality of images captured at a second time different from the first time; and
obtain the mesh information based on a combination of the first mesh information and the second mesh according to the plurality of weights.
